(19) United States
(12) Patent Application Publication
(10) Pub. No.: US 2007/0266083 A1
(43) Pub. Date: Nov. 15, 2007

(54) Resource brokering method, resource brokering apparatus, and computer product

(75) Inventors: Hiromichi Kobashi, Kawasaki (JP); Soichi Shigeta, Kawasaki (JP); Haruyasu Ueda, Kawasaki (JP); Toshihiro Shimizu, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/698,640

(22) Filed: Jan. 25, 2007

(30) Foreign Application Priority Data
Apr. 10, 2006 (JP) 2006-107631
Oct. 19, 2006 (JP) 2006-285397

(51) Int. Cl. G06F 15/16

(52) U.S. Cl. 709/203

(57) ABSTRACT

In a resource brokering apparatus, a setting unit sets a value of each service, and a detecting unit detects whether resource nodes are insufficient when a request for one service is received by a receiving unit. When it is insufficient, a determining unit determines whether a first value of a resource node used for one service is higher than a second value of the resource node which is currently used for another service. If the first value is larger than the second value, the other service is switched to the one service.

### CROSS-REFERENCE TO RELATED APPLICATIONS

This application is based upon and claims the benefit of priority from the prior Japanese Patent Application No. 2006-107631, filed on Apr. 10, 2006 and Japanese Patent Application No. 2006-285397, filed on Oct. 19, 2006, the entire contents of which are incorporated herein by reference.

### BACKGROUND OF THE INVENTION

1. Field of the Invention

The present invention relates to resource brokering of resource nodes used among a plurality of services.

2. Description of the Related Art

Conventionally, lack of flexibility in a system configuration leads to the need of a large amount of additional investment for reinforcement in processing performance. For example, the required peak performance increases with a change in a business situation, resulting in the need of additional computing resources. On the other hand, a large amount of backup resources are sometimes reserved in expectation of a sudden increase in load. However, such resources are often wasted.

A technology relating to the resource brokering includes one described in, for example, Systemwalker Resource Coordinator: Fujitsu, [online], [searched on Apr. 5, 2006], the Internet <URL:http://systemwalker.fujitsu.com/jp/rc/>.

However, each service determines a value of a dedicated resource node based on each standard of value and uses the resource node. In this case, it is difficult to accommodate the resource nodes among the services because of the difference in the standard of value of the resource node among the respective services.

In addition, the resource nodes are ranked also within each service according to priority, and there is a request that the low-priority resource node should be passed first to other services. However, in the case of a top-down method, there is a possibility of allocating the resource node that has been used in high priority to other services. If this happens, processing that has been performed is nullified and the same processing is required to be redone, resulting in protracted processing time.

### SUMMARY OF THE INVENTION

It is an object of the present invention to at least solve the above problems in the conventional technologies.

A computer-readable recording medium according to one aspect of the present invention stores therein a resource brokering program. The resource brokering program causes a computer to set a value of resource nodes relatively to a predetermined standard for each of a plurality of services; to accept a request for one service among services; to detect whether a resource node used for a service is insufficient; to determine, when it is detected that the resource node is insufficient at the detecting, whether the value of a resource node used for a service is higher than the value of a resource node used for another service; and to switch the resource node used for a service to the resource node used for the other service, based on a result of the determination.

A resource brokering apparatus according to another aspect of the present invention includes a setting unit that sets, for each of a plurality of services, a value of resource nodes relatively to a predetermined standard; an accepting unit that accepts a request for a service; a detecting unit that detects whether a resource node to be used for the service is insufficient; a determining unit that determines, when it is detected that the resource node is insufficient by the detecting unit, whether the value of a resource node used for a service is higher than the value of a resource node used for another service; and a switching unit that switches the resource node used for the one service to the resource node used for the other service, on the basis of a result of determination by the determining unit.

A resource brokering method according to still another aspect of the present invention includes setting, for each of a plurality of services, a value of resource nodes relatively to the predetermined standard; accepting a request for one service among the services; detecting whether a resource node used for the one service is insufficient; determining, when it is detected that the resource node is insufficient at the detecting, whether the value of a resource node used for a service is higher than the value of a resource node used for another service; and switching the resource node used for a service to the resource node used for the other service, on the basis of a result of determination at the determining.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 illustrates a system configuration of a resource brokering system according to an embodiment of the present invention;

FIG. 2 is a schematic diagram of a computer device shown in FIG. 1;

FIG. 3 is a block diagram of a resource brokering apparatus according to the embodiment;

FIG. 4 is a flowchart of a resource brokering processing performed by the resource brokering apparatus according to the embodiment;

FIG. 5 illustrates a first specific example of the resource brokering processing;

FIG. 6 illustrates a second specific example of the resource brokering processing;

FIG. 7 illustrates a third specific example of the resource brokering processing;

FIG. 8 illustrates a fourth specific example of the resource brokering processing;

FIG. 9 illustrates a fifth specific example of the resource brokering processing;

FIG. 10 illustrates a sixth specific example of the resource brokering processing;

FIG. 11A is a graph indicating a service processing state before application of the resource brokering processing in a service A;

FIG. 11B is a graph indicating the service processing state after application of the resource brokering processing in a service A;

FIG. 11C is a graph indicating a service processing state before application of the resource brokering processing in a service B;

FIG. 11D is a graph indicating the service processing state after application of the resource brokering processing in a service B;

FIG. 12A is a graph indicating an allocation state of a resource node before application of the resource brokering processing;

FIG. 12B is a graph indicating the allocation condition of the resource node after application of the resource brokering processing;

FIG. 13 illustrates a detailed system configuration of the resource brokering system;

FIG. 14 is a sequence diagram of a resource brokering processing according to a first example;

FIG. 15 illustrates a specific example of a resource brokering processing according to a second example;

FIG. 16 illustrates a specific example of the resource brokering processing according to the second example;

FIG. 17 illustrates a specific example of the resource brokering processing according to the second example;

FIG. 18 illustrates a specific example of the resource brokering processing according to the second example;

FIG. 19 is a schematic diagram illustrating a priority setup in a video conference system;

FIG. 20 illustrates an example of a graphical user interface (GUI) displayed on a computer device;

FIG. 21 is a schematic diagram illustrating the priority setup in a batch processing system;

FIG. 22 illustrates a another specific example of the resource brokering processing according to the second example;

FIG. 23 illustrates a another specific example of the resource brokering processing according to the second example;

FIG. 24 illustrates a another specific example of the resource brokering processing according to the second example;

FIG. 25 illustrates a another specific example of the resource brokering processing according to the second example;

FIG. 26 illustrates a still another specific example of the resource brokering processing according to the second example;

FIG. 27 illustrates a still another specific example of the resource brokering processing according to the second example;

FIG. 28 illustrates a still another specific example of the resource brokering processing according to the second example; and

FIG. 29 illustrates a still another specific example of the resource brokering processing according to the second example.

### DETAILED DESCRIPTION OF THE PREFERRED EMBODIMENTS

Exemplary embodiments of the present invention will be described in detail below with reference to the accompanying drawings.

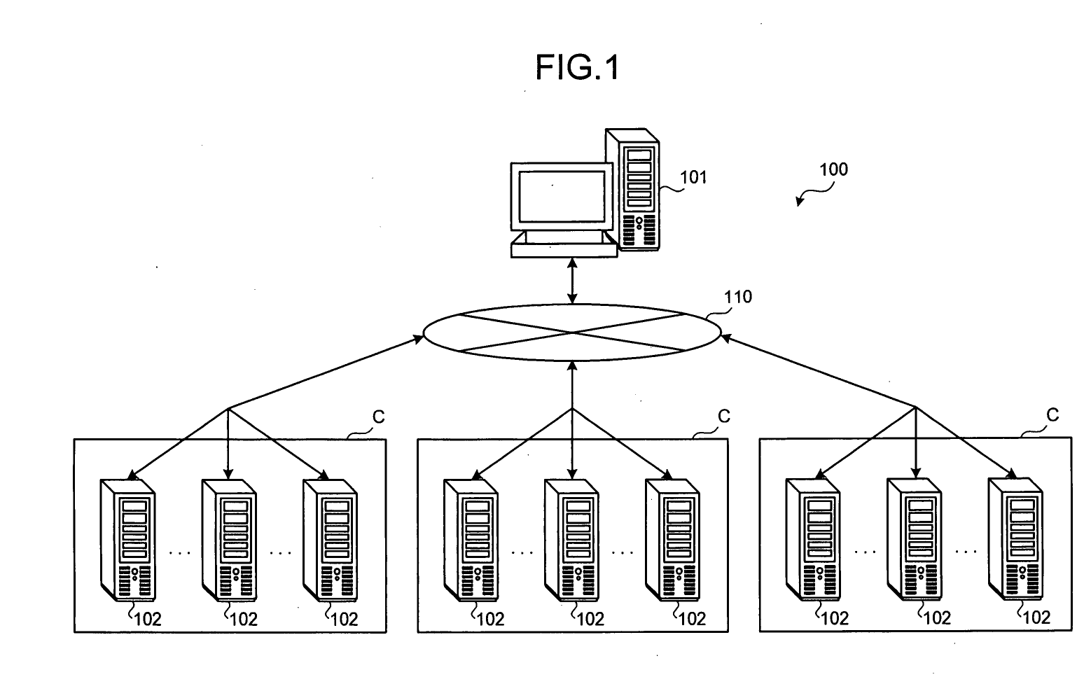

First, a system configuration of the resource brokering system according to an embodiment of the present invention will be described. FIG. 1 illustrates a system configuration of the resource brokering system. As shown in FIG. 1, a resource brokering system 100 has such a configuration that a resource brokering apparatus 101 is communicably connected to resource nodes 102 installed in each site C via a network 110.

The resource brokering apparatus 101 is a computer device that brokers the resource nodes 102 used among a plurality of services. Specifically, the resource brokering apparatus 101 performs determination of a resource node to be allocated among the resource nodes 102 in a site C for a required service, and allocation of the resource node 102 in one of the sites C for another service. The resource node 102 is installed in each site C, and is a computer device that provides a service assigned by the resource brokering apparatus 101 to a terminal (not shown).

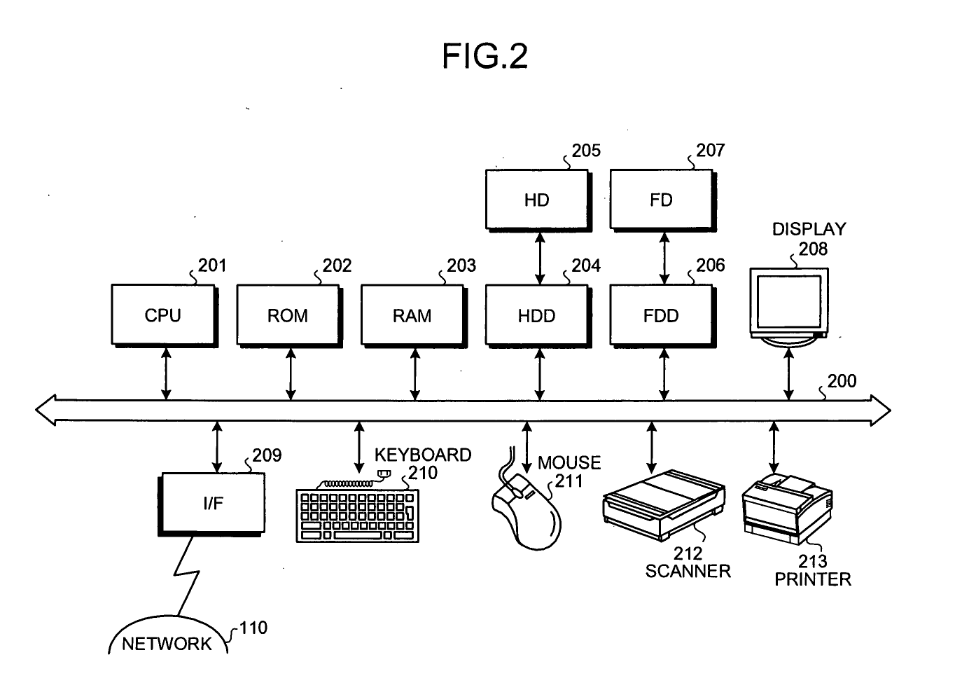

FIG. 2 is a schematic diagram of the computer device shown in FIG. 1. As shown in FIG. 2, the computer device includes a central processing unit (CPU) 201, a read-only memory (ROM) 202, a random-access memory (RAM) 203, a hard disk drive (HDD) 204, a hard disk (HD) 205, a flexible disk drive (FDD) 206, a flexible disk (FD) 207 as an example of a removable recording medium, a display 208, an interface (I/F) 209, a keyboard 210, a mouse 211, a scanner 212, and printer 213. Each component is respectively connected through a bus 200.

The CPU 201 controls the whole computer device. The ROM 202 stores a computer program such as a boot program. The RAM 203 is used as a work area of the CPU 201. The HDD 204 controls read/write of data from/to the HD 205 in accordance with the control by the CPU 201. The HD 205 stores the data written under the control by the HDD 204.

The FDD 206 controls read/write of the data from/to the FD 207 in accordance with the control by the CPU 201. The FD 207 stores the data written under the control of the FDD 206, and causes the computer device to read the data stored in the FD 207.

Besides the FD 207, the removable recording medium may be a compact disc read-only memory (CD-ROM), a compact disc recordable (CD-R), a compact disk rewritable (CD-RW), a magneto optical (MO) disk, a digital versatile disk (DVD), or a memory card. The display 208 displays a cursor, an icon, or a toolbox, as well as the data such as a document, an image, and functional information. As the display 208, a cathode ray tube (CRT), a thin-film transistor (TFT) liquid crystal display, a plasma display, or the like can be employed.

The I/F 209 is connected to the network 110, such as the Internet, via a communication line, and is connected to other devices via this network 110. The I/F 209 manages the interface between the network 110 and the internal components to control I/O of the data from/to an external device. As the I/F 209, a modem, a local area network (LAN) adapter, or the like can be employed.

The keyboard 210 is provided with keys for inputting data such as characters, numbers, and various instructions. A touch panel input pad, a numeric keypad, or the like can be applied instead. The mouse 211 performs functions such as movement of cursor, a range selection, movement of a window, change of size, or the like. It may be replaced by a track ball, a joystick, or the like, as long as the similar functions as a pointing device are provided.

The scanner 212 optically reads the image and captures the image data in the computer device. The scanner 212 may have an optical character recognition (OCR) function. The printer 213 prints the image data or the document data. For example, a laser printer or an ink jet printer can be employed as the printer 213.

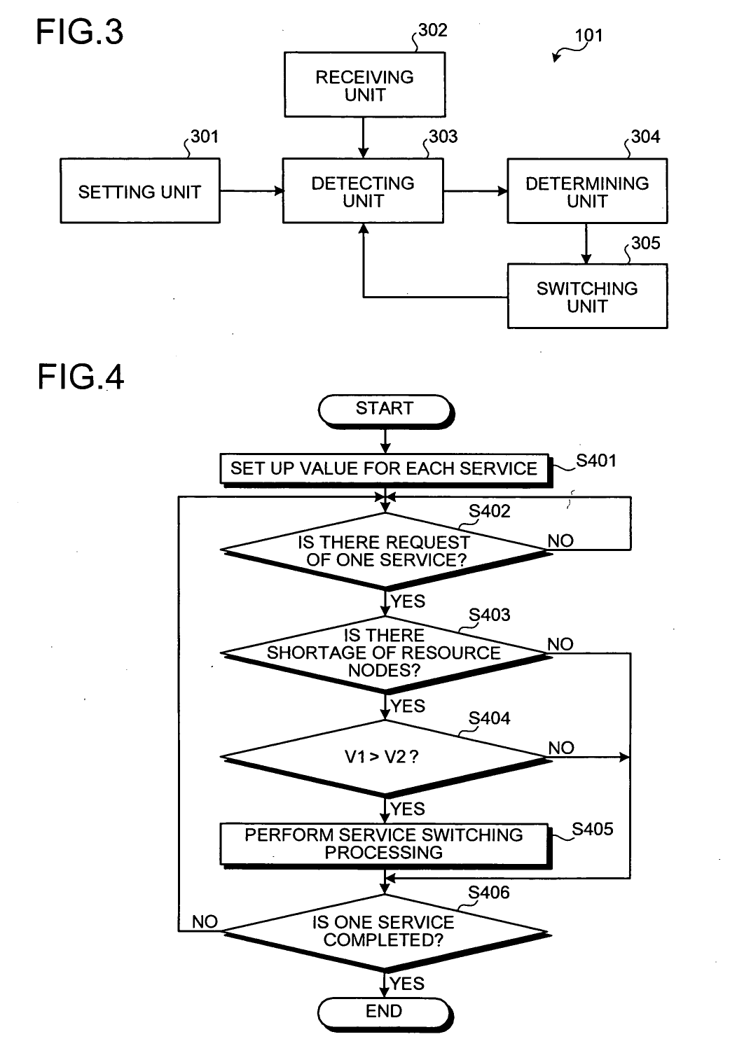

FIG. 3 is a block diagram of the resource brokering apparatus 101. As shown in FIG. 3, the resource brokering apparatus 101 includes a setting unit 301, a receiving unit 302, a detecting unit 303, a determining unit 304, and a switching section 305.

The setting unit 301 sets a value of each of the resource nodes 102 used for respective services, relatively to a predetermined standard of value. The service is information processing provided to a computer terminal of the resource node 102, including a non-interactive service such as data mining, and an interactive service such as an Internet telephone and a video conference system.

The value of the resource node 102 is a value given to the resource node 102 depending on the service running on it, and is an index that represents priority and weight of the service. In a case of providing more than one service at the same time, since each service has a different standard of value, it cannot be determined which resource node 102 of a service should be accommodated when shortage of the resource node 102 arises for a certain service.

For this reason, the setting unit 301 maps the values used by each service to the standard values. This mapping is relatively set among the requested services. For example, let us consider the case that there are an interactive service and a non-interactive service, the value of the resource node 102 used for the interactive service is set so as to be higher than the value of the resource node 102 used for the non-interactive service.

The setting unit 301 can also set the values so as to vary depending on a condition of the resource node 102. For example, when the resource node 102 executes a job for a certain service and the service is switched to a different service during the execution, the longer the execution time of the job is, the more wasted the execution of the job is which has been executed until then. Accordingly, by setting the value of the resource node 102 so as to increase in proportion to the execution time, this resource node 102 may be excluded from a switching target.

Similarly, the values of the resource nodes 102 may be set such that the resource node 102 with higher processing performance (clock frequency of the CPU or memory capacity) has the higher value, or such that the resource node 102 that is used more frequently has the higher value. The resource node 102 that is remotely located has a physically longer communication distance. Accordingly, by setting up the lower value for the resource node 102 located at the site C that is relatively distant compared to others of the resource nodes 102, improvement in the speed of service provision can be achieved.

The setting unit 301 can also set the values of the resource nodes 102 so as to vary depending on specified execution time of the resource node 102. The specified execution time is input by a user when supplying a job for the service. The specified execution time may be a specific length of the execution time or a time period to provide the service.

The value of the resource node 102 whose execution time is given is set so as to be higher than the values of other resource nodes 102 during the execution time. When the execution time of a job is specified, the, the value of the executing node 102 may be set to be variable depending on whether interrupt or termination of the resource node 102 is allowed during the execution time.

In other words, the lower value can be set when interrupt or termination of the resource node 102 is directed during the execution time. At this time, the value of the resource node 102 may be gradually decreased, or be set to the possible lowest value to be assumed as the value of the resource node 102.

The setting unit 301 can also set the value such that the value becomes higher for one of the resource node 102 on which job execution is not completed among the resource nodes 102 used for other services depending on the rate of jobs whose execution is completed among a set of jobs for other services. In other words, when the set of jobs is supplied for other services, the values of the resource nodes 102 are set such that the value of the resource node 102 is larger which is executing the job depending on the rate of the jobs which execution is completed among the set of jobs.

Moreover, the setting unit 301 may set the values so as to increase depending on frequency of switching of the resource nodes 102. Specifically, the values are set so as to increase according to the number of times that the resource node 102 is switched other nodes that are used for other services even while the resource node 102 is used for a certain service.

As described, by increasing the values of the resource nodes 102 in accordance with the increase in the number of switching of the resource nodes 102, the waste of the jobs due to switching can be reduced and the time consumed for completion of the job execution can be shortened.

The receiving unit 302 receives a request for one service among the plural services. Specifically, a type of service, the number of the resource nodes 102 to be used, or the like is received as the request. This request may be received by direct input to the resource brokering apparatus 101, or from an external computer device via the network 110.

The detecting unit 303 detects whether there is shortage of the resource nodes 102 used for one service for which the request is received by the receiving unit 302. Although allocation of the resource nodes 102 is sequentially determined initially in accordance with the order of requests or the value of each service, the number of the resource nodes 102 to be used for the requested service may exceed the total number of the resource nodes 102. Even when the resource nodes 102 are sufficient initially, the number of the resource nodes 102 to be used for the requested service in a process of operating each service may exceed the total number of the resource nodes 102. In such cases, the shortage of the resource nodes is detected.

When the shortage is detected by the detecting unit 303, the determining unit 304 determines whether the value of the resource node 102 used for one service and set by the setting unit 301, is higher than the value of the resource node 102 used for the service other than one service and set by the setting unit 301.

If there is the shortage of the resource nodes and there is a request for the resource node 102 used for a service with a higher value, the resource node 102 used for the service with a lower value should be assigned to the request. By determining whether the value is high or low, the switching target resource node 102 can be determined.

The switching section 305 switches the resource nodes 102 based on a result of determination by the determining unit 304. In other words, when there is the shortage of the resource nodes 102 used for requested one service, the resource node 102 used for other services whose value is lower than that of the resource node 102 used for one service is switched as to be used for one service. When more than one the resource node 102 is used for other services, the resource node 102 with the lowest value among them is preferably switched so as to be used for one service.

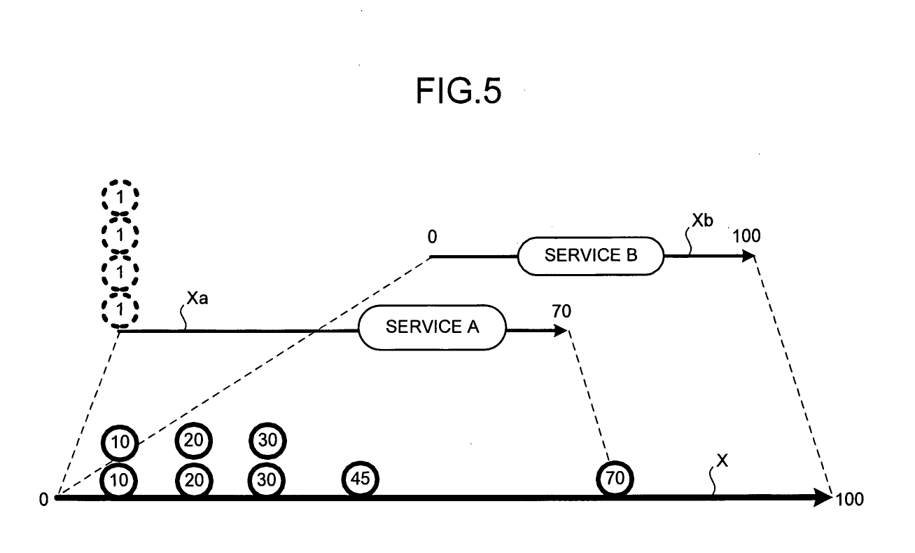

FIG. 4 is a flowchart of a resource brokering process performed by the resource brokering apparatus 101. As shown in FIG. 4, the value of each service is first set by the setting unit 301 (step S401), and the resource brokering apparatus 101 stands by until the request for one service is received by the receiving unit 302 (step S402: NO). When the request for one service is received (step S402: YES), the detecting unit 303 detects whether the resource nodes are short (step S403). If the shortage of the resource nodes is not detected (step S403: NO), the process then proceeds to step S406.

On the other hand, if the shortage of the resource nodes is detected (step S403: YES), the determining unit 304 determines whether the value (V1) of the resource node 102 used for one service is higher than the value (V2) of the resource node 102 which is currently used for another service (step S404). If V1>V2 is not satisfied (step S404: NO), the procedure then proceeds to step S406. In contrast, if V1>V2 is satisfied (step S404: YES), another service provided by the resource node 102 which is currently used is switched to one service (step S405).

Then, it is determined whether one service is completed (step S406), and if it is not completed (step S406: NO), the process then returns to step S402. On the other hand, if one service is completed (step S406: YES), a series of processing is then terminated.

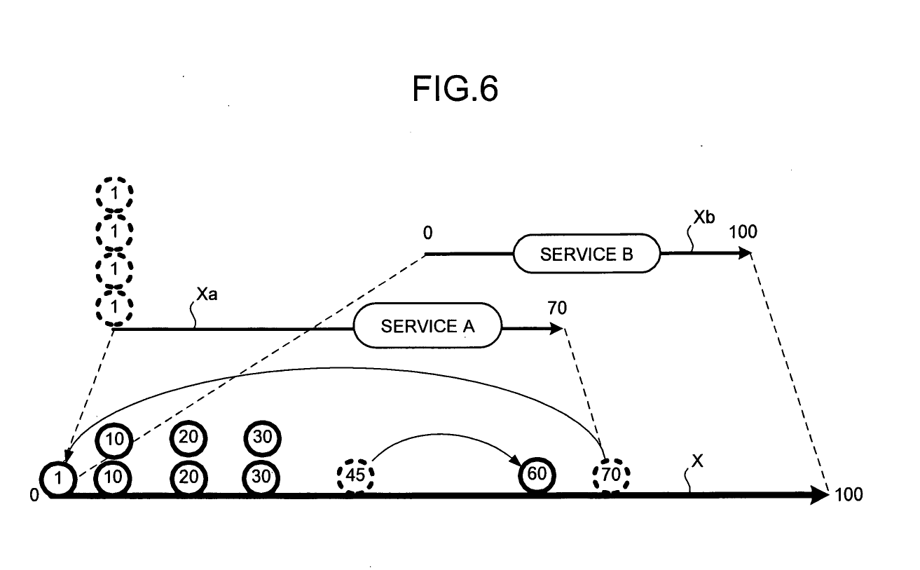

FIGS. 5 through 10 illustrate specific examples of the resource brokering processing. For example, a service A is the non-interactive data mining and a service B is the interactive Internet telephone.

A value Va of the resource node 102 used for the service A is set as 1≦Va≦70. The value Va increases in proportion to the length of the job execution time of the service A. An initial value of the value Va is set as Va=1.

A value Vb of the service B takes a binary value as follows. Vb=100 (resource node execution) Vb=0 (end of resource node execution)

Referring to FIGS. 5 through 10, a standard of value Xa of the service A specifies the range of the value Va, and a standard of value Xb of the service B specifies the range of the value Vb. The standards of value Xa and Xb are mapped on a common standard of value X. A circle figure represents the resource node 102 and a number in the circle figure represents the value.

Specifically, the circle figured whose numbers are 1 to 70 represent the resource nodes 102 used for the service A, and the circle figure whose number is 100 represents the resource node 102 used for the service B. A dotted circle figure above the standards of value Xa and Xb represents the requested resource node 102, i.e., the resource node 102 that is short.

First, there are four dotted circle figures whose number are “1” in FIG. 5, the service A is short of four resource nodes 102. In the phase of FIG. 5, the values Va of the resource nodes 102 used for the service A vary as Va=10, 20, 30, 45, and 70. In other words, it means that the resource node 102 represented by Va=70 continues execution of the data mining for the longest time. In FIG. 5, assume that the service B does not request the resource node 102.

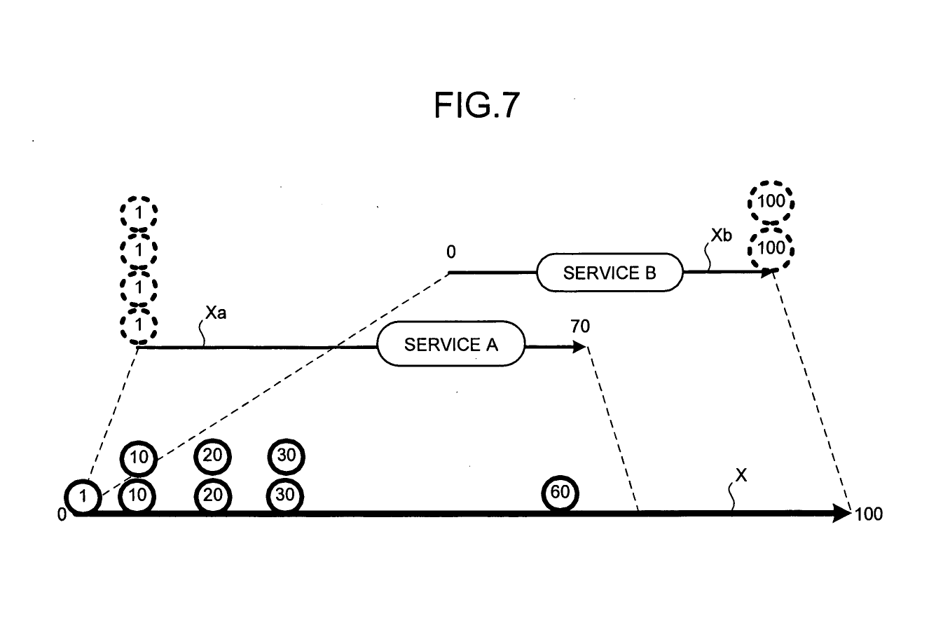

Referring to FIG. 6, when execution of the data mining by the resource node 102 represented by Va=70 is completed, the value Va of this resource node 102 returns from 70 to 1. In this connection, the value Va of the resource node 102 represented by Va=45 is increased to Va=60.

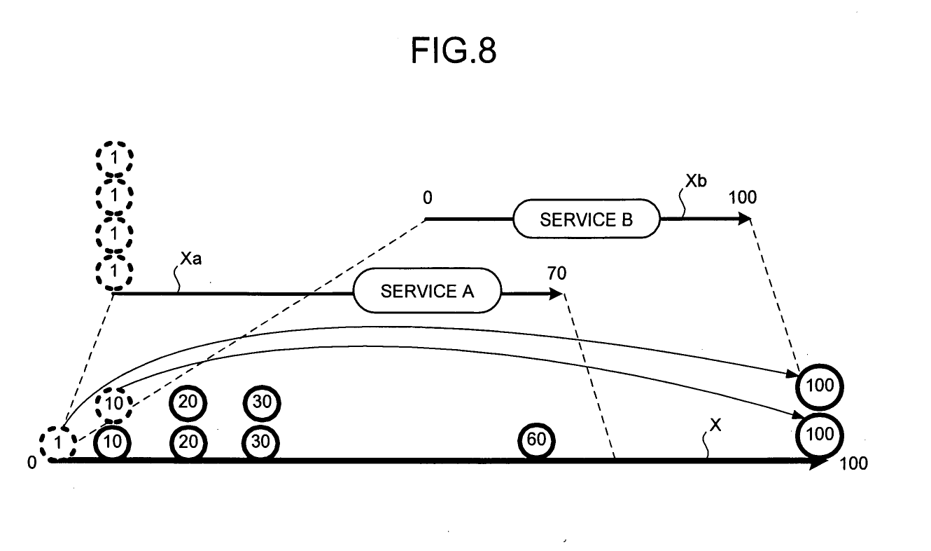

Referring to FIG. 7, two resource nodes 102 used for the service B are requested. Since the value Vb of the resource node 102 used for the service B is Vb=100, i.e., Vb>Va, and the service B is executed prior to the service A.

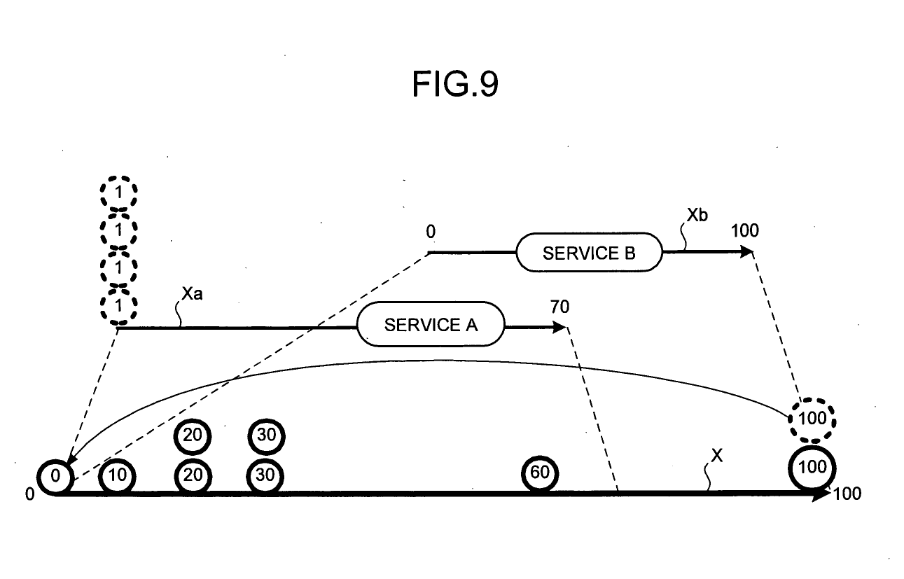

For this reason, in FIG. 8, the resource node 102 with the lower value Va among the resource nodes 102 used for the service A is allocated to the service B. Since two resource nodes 102 are requested to be used for the service B in this case, the resource nodes 102 with the lower values Va (Va=1, 10) among eight resource nodes 102 (Va=1, 10, 10, 20, 20, 30, 30, and 60) used for the service A are allocated to the service B. In other words, the resource node 102 for which job execution time is longer among the resource nodes 102 used for the service A is excluded from the switching target to the service B.

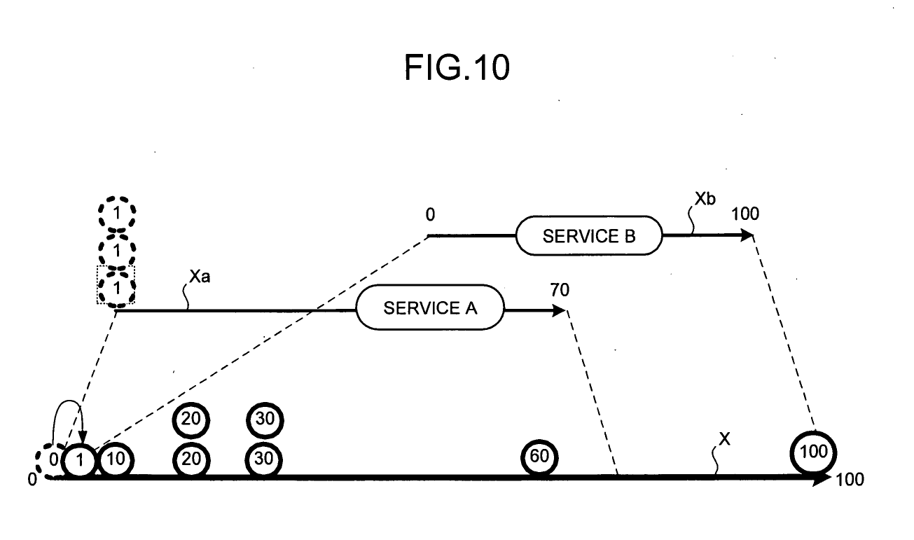

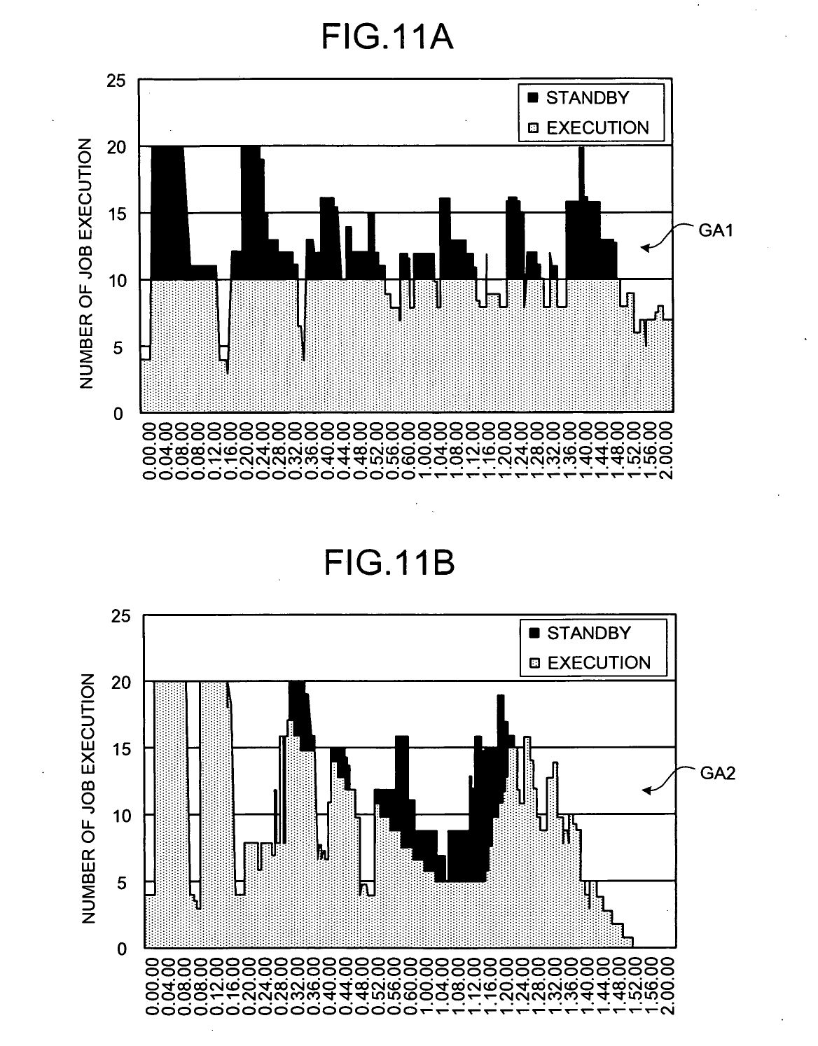

Referring to FIG. 9, one resource node 102 between two resource nodes 102 used for the service B completes the execution, the value Vb of this one resource node 102 is decreased from 100 to 0. Referring to FIG. 10, when there is no request of the resource node 102 for the service B and there is the request of the resource node 102 for the service A, the resource node 102 for the service B whose value is turned to 0 is allocated to the service A.

By the brokering processing illustrated in FIGS. 5 through 10, when the services A and B are simultaneously provided, the resource nodes 102 can be effectively utilized. In particular, the job execution time of the data mining can be shortened in the service A, while the receivable number of the Internet telephones can be increased in the service B.

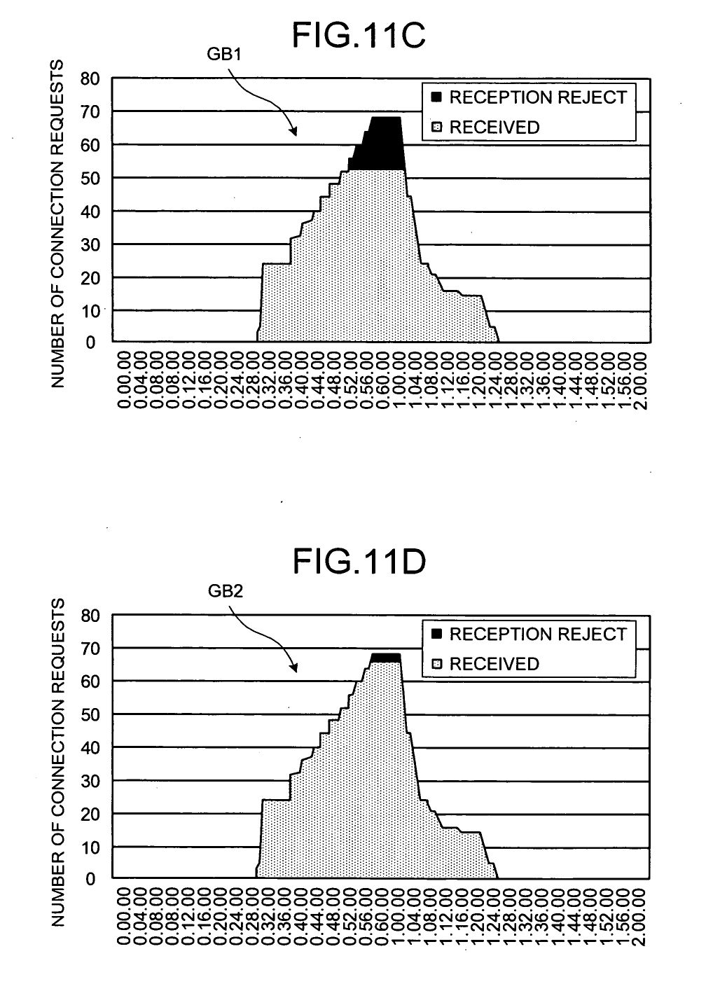

FIGS. 11A through 11D are graphs illustrating the service processing states before and after application of the resource brokering processing. FIG. 11A is a graph illustrating the service processing state before application of the resource brokering processing in the service A, and FIG. 11B is a graph illustrating the service processing state after application of the resource brokering processing in the service A. In each of graphs GA1 and GA2, an abscissa represents time and an ordinate represents the number of job execution.

In the graphs GA1 and GA2, a black region represents a standby state and a shaded region represents a job execution state. When comparing the graphs GA1 and GA2, the area of the black region is less in the graph GA2, which means that the data mining is performed efficiently.

FIG. 11C is a graph illustrating the service processing state before application of the resource brokering processing in the service B, and FIG. 11D is a graph illustrating the service processing state after application of the resource brokering processing in the service B. In each of graphs GB1 and GB2, an abscissa represents time and an ordinate represents the number of connection requests.

In graph GB1 and GB2, a black region represents a reception reject state and a shaded region represents a received state (under the job execution). When comparing the graphs GB1 and GB2, the area of the black region is less in the graph GB2, which means that an interactive communication by the Internet telephone is performed efficiently.

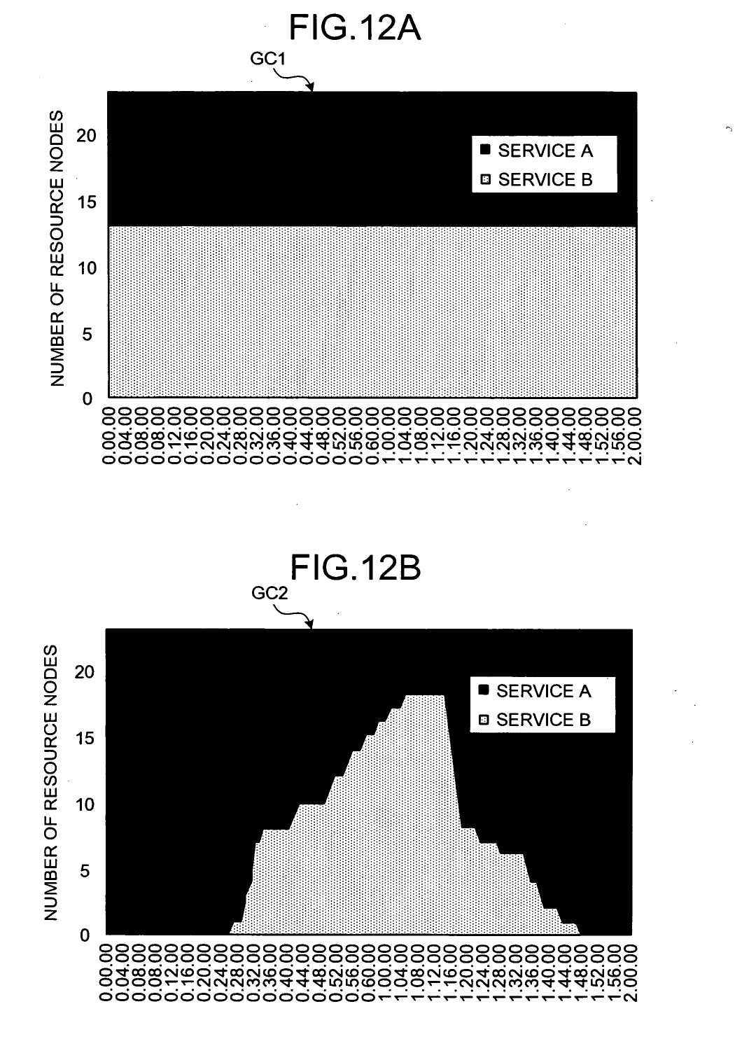

FIGS. 12A and 12B are graphs illustrating the allocation states of the resource node 102 before and after application of the resource brokering processing. Referring to FIGS. 12A and 12B, respectively, a graph GC1 is a graph before application of the resource brokering processing and a graph GC2 is a graph after application of the resource brokering processing. In both of the graphs GC1 and GC2, an abscissa represents time and an ordinate represents the number of the allocated resource nodes 102.

In both of the graphs GC1 and GC2, a black region represents the service A and a shaded region represents the service B. Referring to the graph GC1 before application, the number of the resource nodes does not vary with time because the number is fixed for each service. In contrast, referring to the graph GC2 after application, the resource nodes are allocated to the service B prior to the service A, so that the number of the resource nodes used for the service A decreases as the number of the resource nodes used for the service B increases.

As described, according to the embodiment of the present invention, the standard of value of each service can be unified into the unitary standard of value, so that the priority of the services can be controlled and reflected in the brokering. In addition, since the value of the resource node 102 used for the service varies depending on the state, the resource node 102 with the relatively low value is included in the switching target of the service while the resource node 102 with the high value can be excluded from the switching target of the service, so as to accommodate the resource nodes 102 among the services efficiently. Thus, the respective services can be smoothly provided.

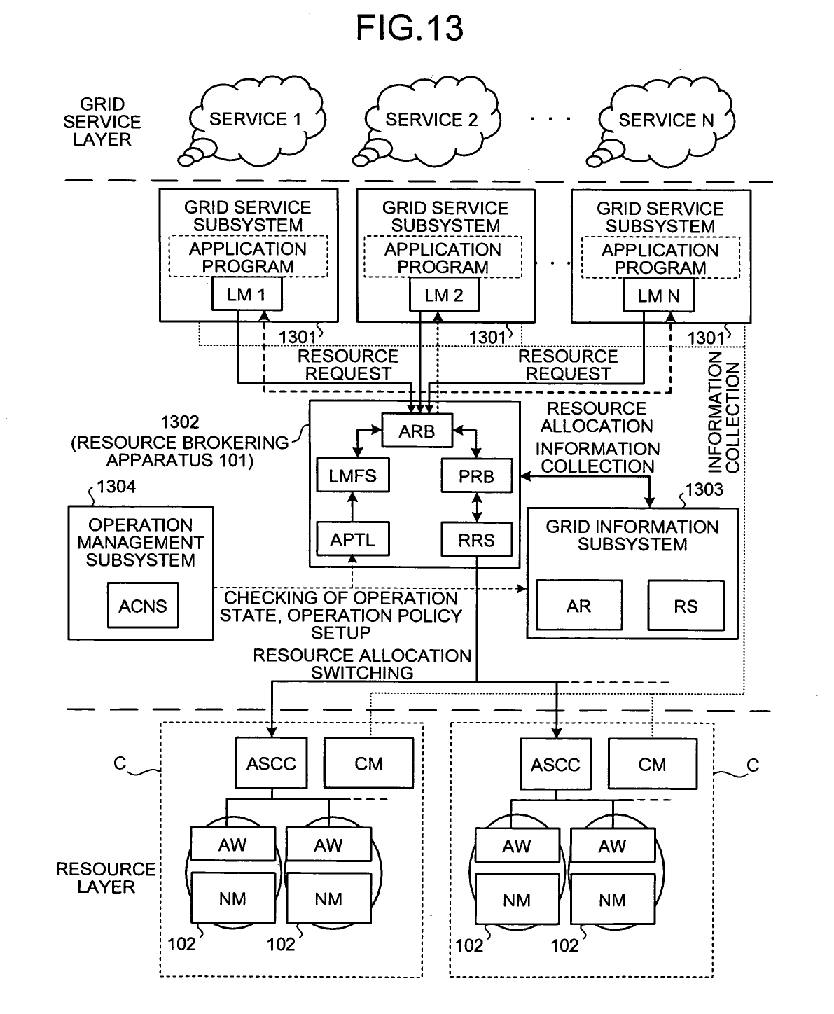

FIG. 13 illustrates a detailed system configuration of the resource brokering system 100 of a first example. The resource brokering apparatus 101 includes a grid service subsystem 1301, a resource brokering subsystem 1302, a grid information subsystem 1303, and an operation management subsystem 1304.

The grid service subsystem 1301 is a subsystem that achieves each service performed in a grid, which is prepared per each type of service. The grid is a technique to connect a plurality of computer systems distributed geographically to combine as one virtual system that provides computing power. The grid service subsystem 1301 causes an existing application program to accommodate to a grid environment, so as to be executed as the service on the resource brokering apparatus 101.

The resource brokering subsystem 1302 receives a resource request from the grid service subsystem 1301 to broker the physical resource node 102 required for execution of the service. Distribution of resource allocation for each service is dynamically adjusted so that the resource request for the high-priority service is satisfied. The resource brokering subsystem 1302 has a function to arbitrate the resource request based on the priority of the service or the resources, and a function to switch the application program to be executed for the respective resource nodes 102.

The grid information subsystem 1303 is a subsystem which collects and provides various kinds of information in the resource brokering apparatus 101. For example, the grid information subsystem 1303 collects and provides the information regarding the respective resource nodes 102 (the performance of the CPU or the type of the OS) or the information regarding the respective services (the load or an acquisition condition of the resource node 102).

The operation management subsystem 1304 is a subsystem for performing operation management of the resource brokering apparatus 101. The operation management subsystem 1304 checks an overall operation state or sets an operation policy of the resource brokering apparatus 101.

As shown in FIG. 13, a life cycle manager LM# (# represents a number of 1 to N) is a module of the grid service subsystem 1301. The life cycle manager LM# is prepared per each service, manages the resource node 102 allocated to the service from the start of service to the end thereof, and requests addition or release of the resource node 102 to an arbitrator ARB in accordance with variation of the load of the service. The life cycle manager LM# has a function of autonomously adjusting the priority of the managed resource nodes 102.

A life cycle manager factory service LMFS is a module of the resource brokering subsystem 1302, and performs initiation and halt of the service. When an initiation request of the service is received, the life cycle manager factory service LMFS requests the resource node 102 for performing the life cycle manager LM# for the service and initiates the life cycle manager LM# by the allocated resource node 102. When a halt request of the service is received, the life cycle manager factory service LMFS halts the life cycle manager LM# for the service to release the resource node 102.

The arbitrator ARB is a module of the resource brokering subsystem 1302, and receives an addition/release request of the resource node 102 from the life cycle manager LM# to allocate the resource node 102 to each service. The arbitrator ARB also performs arbitration based on the priority of each service, and concentrates the computing power of the grid on the high-priority service.

A physical resource broker PRB is a module of the resource brokering subsystem 1302. The physical resource broker PRB brokers the resource node 102 with the capability or function to perform the service to the arbitrator ARB based on physical attribution information of each resource node 102 in the grid.

A resource roll switcher RRS is a module of the resource brokering subsystem 1302. The resource roll switcher RRS performs switching of the service (application program) performed by each resource node 102.

A node monitor NM is a module for the grid information subsystem 1303. The node monitor NM is arranged per each resource node 102 that collects the information on the resource node 102 (the type, the load, a memory activity ratio, or the like of the CPU) and reports to a cluster manager CM periodically. A physical switcher ASCC physically performs service switching processing of the resource node 102 in accordance with logical switching processing in the resource brokering subsystem 1302.

The cluster manager CM is a module for the grid information subsystem 1303, and is arranged per each site C. The cluster manager CM relays information collected from the node monitor NM in the site C to a root server RS.

The root server RS is a module of the grid information subsystem 1303, and collects the information on all the resource nodes 102 in the grid. An archiver AR is a module of the grid information subsystem 1303, and accumulates and puts in a database the information collected by the root server RS. A search function of the database is provided to the resource brokering subsystem 1302.

An application wrapper AW is a module for the resource brokering subsystem 1302, and is a module arranged per each resource node 102 of the grid that wraps an API of the application program executed by the resource node 102 and connects the application program and the life cycle manager LM#.

An administration portal APTL is a module of the resource brokering subsystem 1302, and provides an interface for an administrator of the service executed by the grid to perform initiation and halt of the service.

An administration console ACNS is a module of the operational administration subsystem 1304, and provides an interface for the administrator of the resource brokering apparatus 101 to perform setup and adjustment of the whole resource brokering system 100.

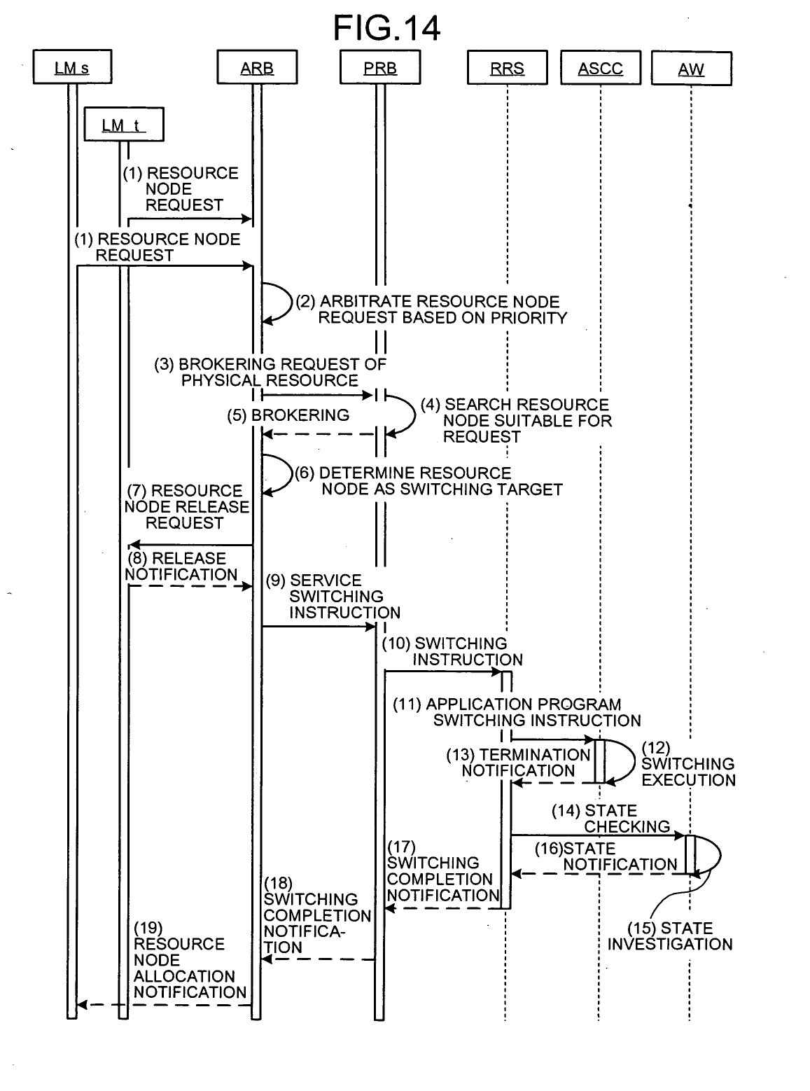

FIG. 14 is a sequence diagram illustrating the resource brokering processing in the first example. The example shown in FIG. 14 illustrates a typical operation sequence regarding the request and allocation of the resource node 102. In this case, it is assumed that the priority of a service s is higher than that of a service t. A number in parentheses represents the order of sequence.

Since the arbitrator ARB arbitrates the resource node request from each life cycle manager LM# based on the priority of service, the request for the life cycle manager LM# of the service s (hereinafter, referred to as “LMs”) is treated prior to the request for the life cycle manager LM# of the service t (hereinafter, referred to as “LMt”).

Referring to FIG. 14, as a result of arbitration by the arbitrator ARB, it is determined that the resource node 102 allocated to the service s is switched to the resource node 102 for the service t, and the respective modules of the physical resource broker PRB, the resource roll switcher RRS, the physical switcher ASCC, and the application wrapper AW cooperate to perform switching.

According to the first example, the total cost can be reduced. Specifically, servers structured as separate systems can be integrated to one system, the servers which are distributed geographically can be integrated to one system, the existing application programs can be readily transferred into the grid environment, or the peak performance of each service can be improved by accommodating a margin of the resource node 102 among the plurality of services. Moreover, more than one service can be managed with one common method.

Furthermore, the system that can flexibly respond to the change in the situation of business can be realized. Specifically, the computing power in accordance with a required quantity can be automatically supplied to the service, the computing power can be automatically concentrated on the high-priority service, or the priority of service can be autonomously adjusted in accordance with the change in the state.

In a second example, the priority of the resource nodes 102 set by the arbitrator ARB (see FIG. 13) of the resource brokering system 100 is specifically described.

The priority of the resource nodes 102 used for the service is set according to the job execution time, the processing performance of the resource node 102, the relative communication distance with other resource nodes 102, or the like. In the second example, the other standard of value is further added to set the priority of resource node 102.

First, the case will be described where the priority of the resource node 102 is set in accordance with the job execution time specifically input when supplying the job for the service. The job execution time may be specific time (for example, 2 hours) to be spent on execution of the job, or may be the time period (for example, 15:00 to 17:00) when the job is executed.

The job execution time is specifically input by the service administrator into the grid service subsystem 1301 when supplying the job. The arbitrator ARB of the resource brokering subsystem 1302 receives the specifically input job execution time from the life cycle manager LM# of the grid service subsystem 1301 to set the priority of the resource node 102.

At this time, the priority of the resource node 102 for which job execution time is specified is set higher than the priority of other resource nodes 102 within the specified job execution time. In other words, the priority of the resource node 102 whose job execution time is specified increases in the value higher as compared to other resource nodes 102 within the specified job execution time.

An upper limit of the value is that of the resource nodes 102 used for the respective services. For example, if the upper limit of the value Va of the resource node 102 used for the service A is as 1≦Va≦70, the upper limit is then Va=70.

When the job execution time has elapsed, the priority is gradually decreased rather than releasing the resource node 102 immediately. In other words, when the job execution time has elapsed, the value of the resource node is gradually decreased rather than setting the value to a lower limit or to the value lower than that required by the service.

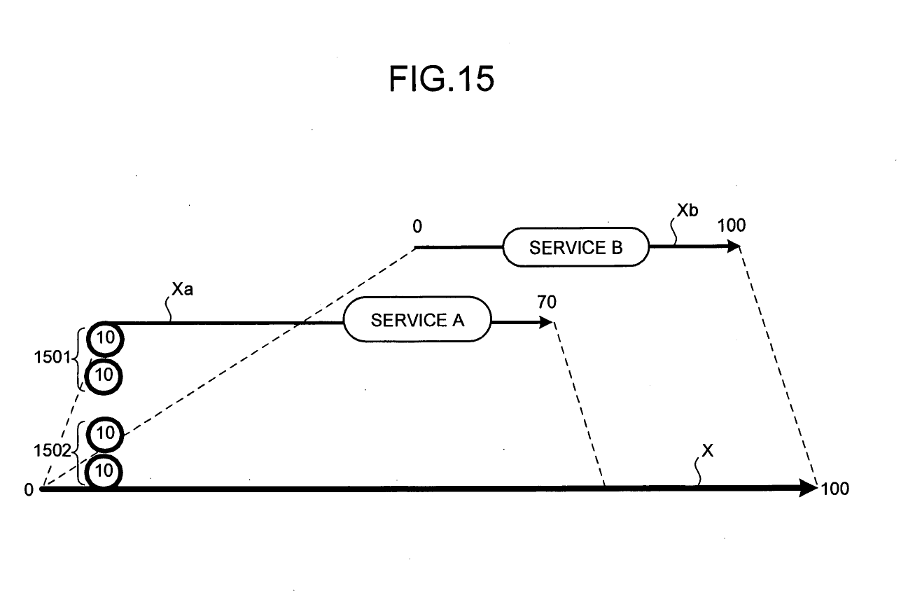

FIGS. 15 through 18 illustrate specific examples of the resource brokering processing in the second example. It is assumed that the services A and B are provided. The value Va of the resource node 102 used for the service A is set as 1≦Va≦70. The value Vb of the service B takes the binary value, i.e., Vb=100 (resource node execution) or Vb=0 (end of resource node execution).

Referring to FIGS. 15 through 18, the standard of value Xa of the service A specifies the range of the value Va, and the standard of value Xb of the service B specifies the range of the value Vb. The standards of value Xa and Xb are mapped on the common standard of value X.

Referring to FIG. 15, there are four resource nodes 102 which execute the job for the service A and the value Va of each resource node 102 is Va=10. While the value Va increases in proportion to the length of the job execution time of the service A, the value accompanying the job execution time is added when the execution time is specified.

Specifically, the job execution time is specified for two resource nodes 102 (execution time specified job 1501) among the four resource nodes 102 which execute the job for the service A. The two resource nodes 102 whose job execution time is not specified are set as execution time non-specified jobs 1502.

For this reason, while the value Va of the execution time specified job 1501 increases in proportion to the length of the job execution time, the value accompanying the job execution time is added during the specified job execution time. Since the job execution time is not specified for the execution time non-specified job 1502, the value Va increases only in accordance with the length of the job execution time which has actually elapsed.

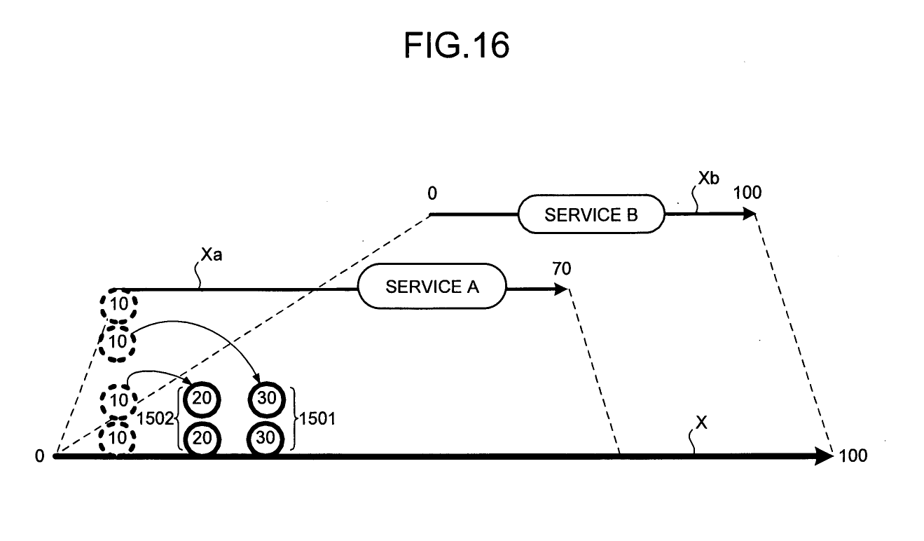

Referring to FIG. 16, after given time has elapsed, the value Va of the execution time non-specified job 1502 is increased from Va=10 to Va=20 as the job execution time elapses. Meanwhile, the value Va of the execution time specified job 1501 is increased from Va=10 to Va=20 as the job execution time elapses, and is further increased from Va=10 to Va=30 in accordance with the specification of the job execution time.

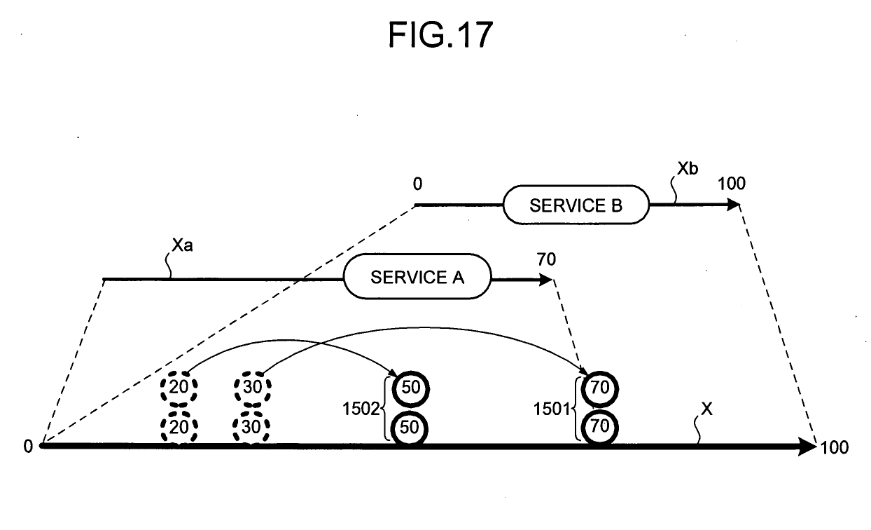

Referring to FIG. 17, when the time further elapses so that the time equals to (the specified job execution time−Δt), the value Va of the execution time specified job 1501 is increased to the upper limit, i.e., Va=70, and is not increased further than this value. Meanwhile, the value Va of the execution time non-specified job 1502 is increased from Va=20 to Va=50 as the job execution time elapses.

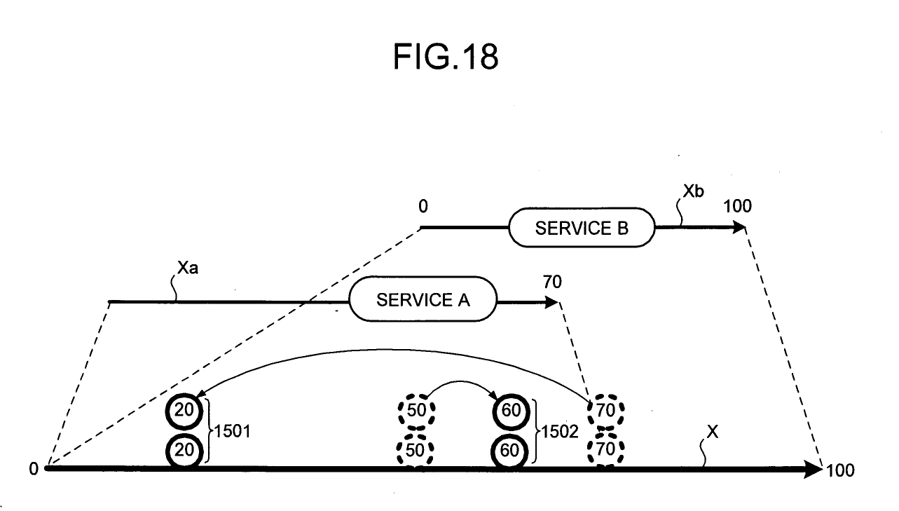

Referring to FIG. 18, when the specified job execution time elapses for the execution time specified job 1501, the value Va is gradually decreased rather than releasing the resource node 102 (the execution time specified job 1501) immediately. Here, the value Va of the execution time specified job 1501 decreases from Va=70 to Va=20. Meanwhile, the value Va of the execution time non-specified job 1502 is increased from Va=50 to Va=60 as the job execution time elapses.

According to the brokering processing shown in FIGS. 15 through 18, the priority (value) of the resource node 102 can be set higher during the specified job execution time. For this reason, even the low-priority job due to the short length of the execution time can be stably executed to the end within the specified execution time (particularly, when the completion of the job execution approaches).

In other words, for the job with less increase in the priority as the execution time elapses, it can prevent the job execution from being retried by the job being switched by other services during execution. Thus, the wasteful computation in each resource node 102 can be reduced.

Next, the case will be described where the user is provided with a GUI that can specify whether interrupt or termination of the job execution is allowed during executing the job which interacts with an external environment.

Specifically, by displaying the GUI on the computer device for the service using the application program of the grid service subsystem 1301, release of the resource node 102 is permitted by the service administrator. In other words, the resource node 102 is not automatically released by the arbitrator ARB, but whether the resource node 102 is released is determined based on permission by the service administrator.

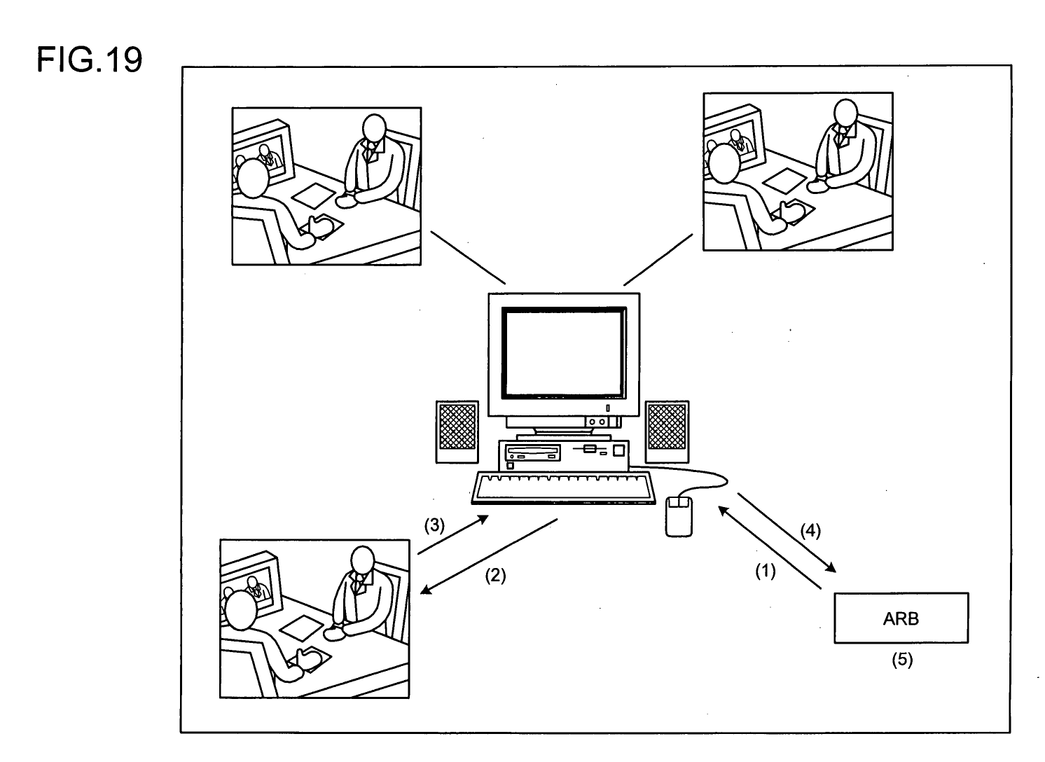

First, there will be described a priority setup in the case where the video conference is performed which interacts with the external environment. FIG. 19 is a schematic diagram illustrating the priority setup in the video conference system. It is assumed that the execution time (termination time) of the video conference is specified preliminarily by the service administrator.

First, when it becomes five minutes before the specified termination time of the video conference, the arbitrator ARB requests the application program of the grid service subsystem 1301 to display the GUI which can specify whether interrupt of the job execution is allowed (1). The time to request to display the GUI can be set arbitrarily, which may be ten minutes before the termination time of the video conference, for example.

Next, the application program of the grid service subsystem 1301 which received the display request displays the GUI on the display of the computer device for the video conferences (2).

The specific input regarding termination of the video conference by a participant at the video conference is received (3), and the received specific input is sent to the arbitrator ARB (4). The arbitrator ARB then sets the priority of the resource node 102 based on the received specific input (5).

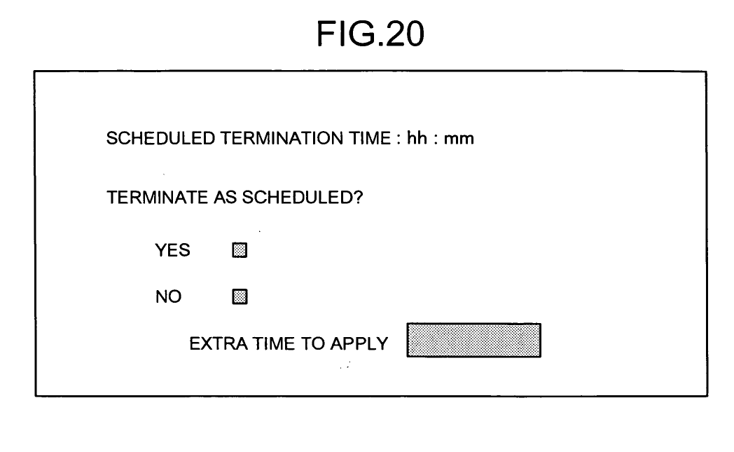

FIG. 20 illustrates an example of the GUI displayed on the computer device. Referring to FIG. 20, schedule termination time of the video conference is displayed on the GUI, as well as options which specify whether the video conference is terminated on this time. The scheduled termination time of the video conference displayed here is the execution time of the video conference which is specified preliminarily.

If the video conference is terminated as scheduled, “YES” on the GUI is specified. Specifically, the participant at the video conference operates the cursor displayed on the GUI to click on the icon corresponding to “YES”.

In this case, the arbitrator ARB terminates the video conference based on the execution time of the video conference specified preliminarily to release the resource node 102. Here, in 5 minutes, arbitrator ARB will terminate a video conference and will release resource node 102.

Meanwhile, if the schedule is changed and the video conference is extended, “NO” on the GUI is specified and extra time to apply is input. In this case, the arbitrator ARB sets the priority of the resource node 102 based on the input extra time.

Specifically, if the extra time is input, the priority of the resource node 102 is set high until the extra time elapses to prevent the resource node 102 from being allocated to other services. When the extra time elapses, the arbitrator ARB terminates the video conference and releases the resource node 102.

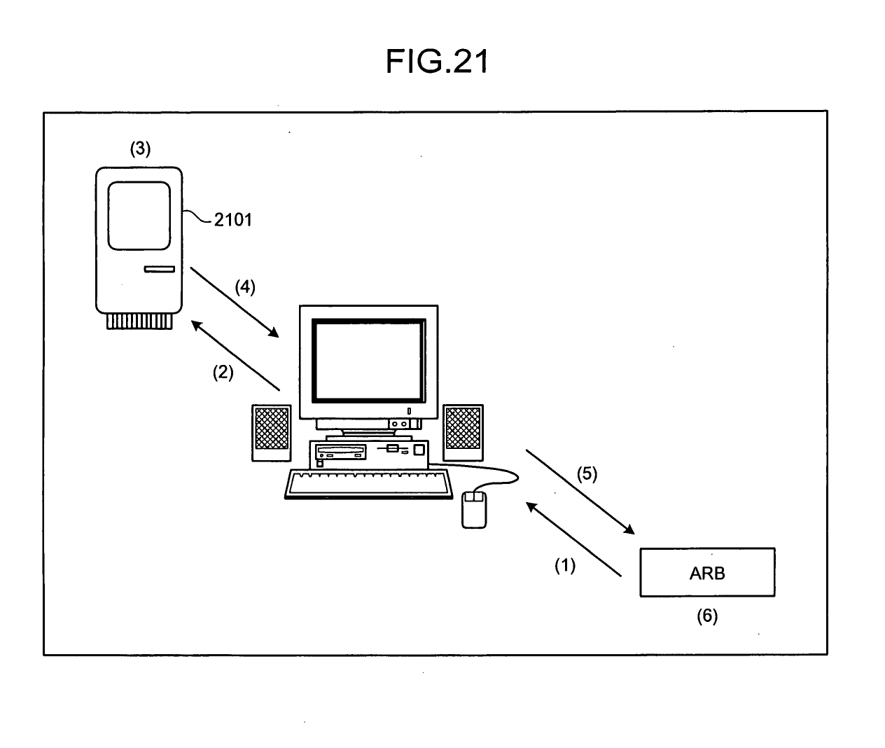

FIG. 21 is a schematic diagram illustrating the priority setup in a batch processing system. It is assumed that the execution time (termination time) of the batch processing is specified preliminarily by the service administrator. It is also assumed that the execution rate that each job occupies is known in the batch processing system (set of a plurality of jobs). In addition, the system has an interface which inquires whether to interrupt or terminate the batch processing.

First, when it becomes one minute before the specified termination time of the batch processing, the arbitrator ARB inquires whether to interrupt or terminate the batch processing to the application program of the grid service subsystem 1301 (1).

Next, the application program of the grid service subsystem 1301 which received the inquiry inquires whether to interrupt or terminate the batch processing to a job execution computer 2101 which is performing the batch processing (2).

The job execution computer 2101 which received the inquiry determines whether 90% of computation to be executed in the batch processing is completed (3). The determination result is returned to the application program of the grid service subsystem 1301 as the inquiry result (4). In other words, the inquiry result which indicates whether interrupt of the batch processing is allowed is returned.

Next, the application program of the grid service subsystem 1301 sends the inquiry result received from the job execution computer 2101 to the arbitrator ARB (5). The arbitrator ARB then sets the priority of the resource node 102 based on the received inquiry result (6).

Specifically, when received the inquiry result which indicates that interrupt of the batch processing is not allowed, the arbitrator ARB sets the priority of the resource node 102 so as to prevent it from being allocated to other services.

Meanwhile, when received the inquiry result which indicates that interrupt of the batch processing is allowed, the arbitrator ARB terminates the batch processing and releases the resource node 102. Here, the arbitrator ARB terminates the batch processing and releases the resource node 102 one minute later.

As described, by setting up the priority of the resource node 102 in accordance with the state of the service which varies fluidly, more efficient brokering can be performed. For example, when there is the specific input to extend the job execution time, for example, it can prevent the resource node 102 to be switched to other services by setting up the priority of the resource node 102 to be high.

Next, the case will be described where the priority is set in accordance with the rate of the jobs whose execution is completed among the set of jobs when the set of jobs is supplied for the service. The set of jobs is a job group supplied when the plurality of jobs need to be executed for providing the service. For example, a collection of search jobs of each partial space when searching a certain space is called the set of jobs.

A problem occurs that the time required for executing the whole job (whole set) increases due to the execution of a small number of jobs among the set of jobs being not completed. Here, the priority for the active job among the set of jobs is set high in accordance with the rate of the jobs whose execution is completed, so that the execution of the whole jobs is completed early.

Specifically, the arbitrator ARB receives an identifier that identifies the set of jobs and an execution status of each job from the life cycle manager LM# of the grid service subsystem 1301. The arbitrator ARB then sets the priority for the currently active job based on the identifier that identifies the set of jobs and the execution status of each job received.

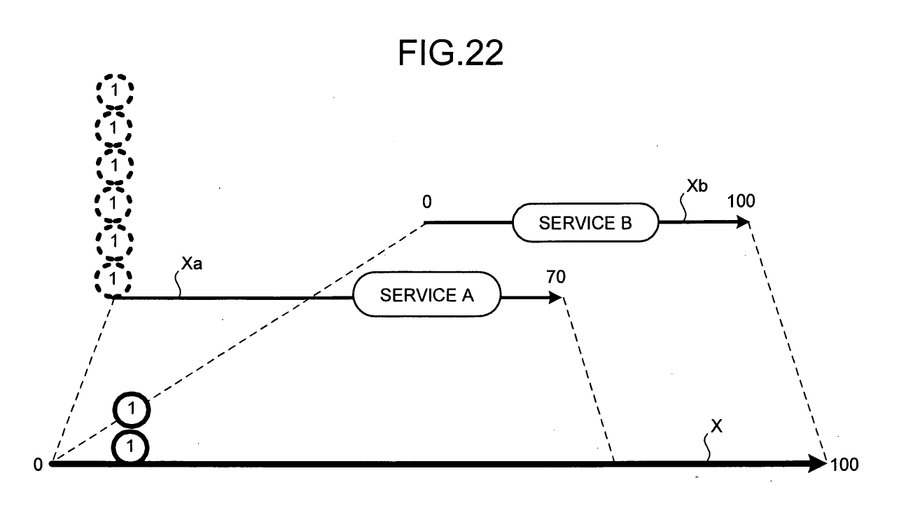

Specific examples of the resource brokering processing in the case where the priority is set in accordance with the rate of the job whose execution is completed among the set of jobs will be described, with reference to FIGS. 22 through 25. FIGS. 22 through 25 illustrate other specific examples of the resource brokering processing in the second example.

Referring to FIG. 22, eight jobs (set of jobs) associated with the service A are supplied and two of them are being executed. In other words, the resource nodes 102 are allocated to two jobs among the supplied eight jobs. At this time, the value Va of two resource nodes 102 allocated to the jobs is Va=1.

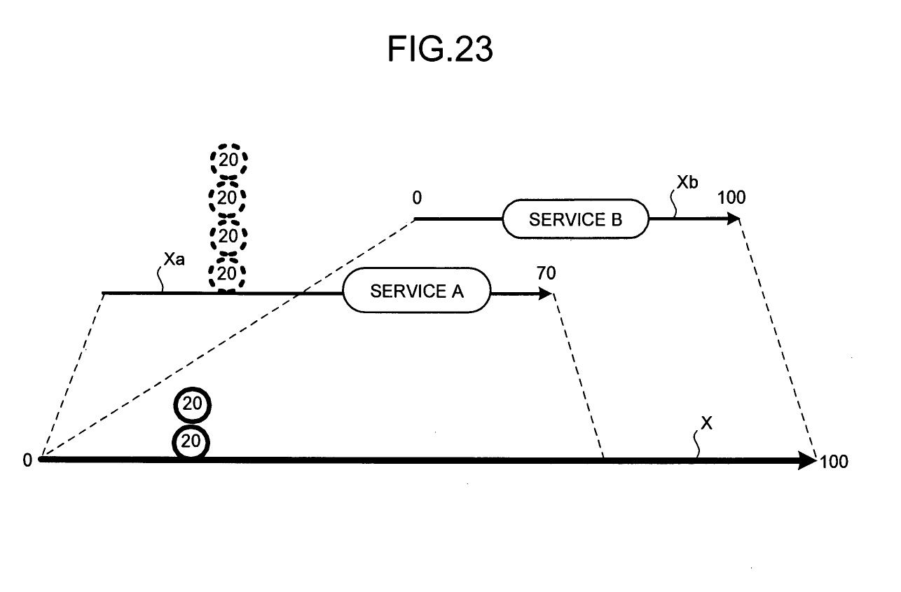

Referring to FIG. 23, after given time has elapsed, the resource nodes 102 are allocated to four jobs among the supplied eight jobs and, as a result, two of the jobs are completed. Thus, the value Va of two resource nodes 102 performing the job is increased from Va=1 to Va=20.

In other words, since the rate of the jobs (two out of eight) whose execution is completed among the supplied jobs has increased, the value Va of the resource node 102 for which execution of the job is not completed is increased. The increase in the value accompanying the elapse of the job execution time is also included (this is similarly applied hereinbelow).

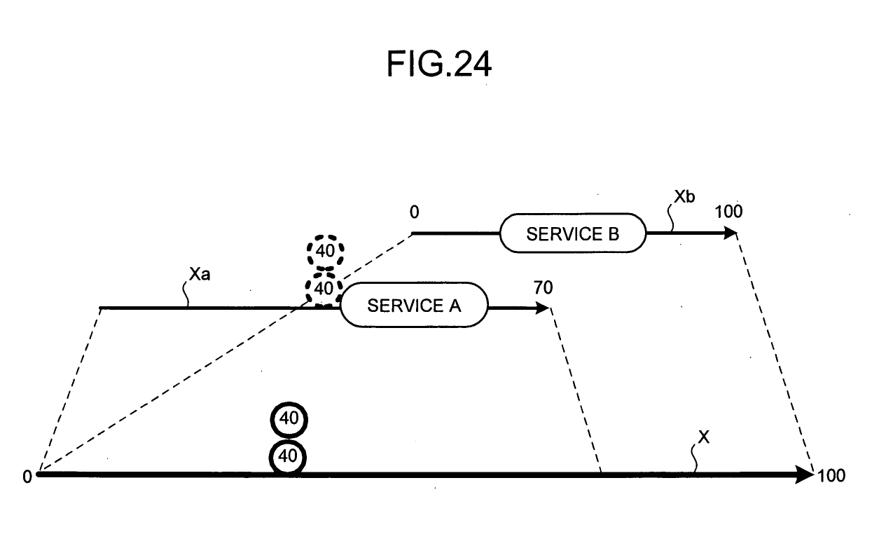

Referring to FIG. 24, after further given time has elapsed, the resource nodes 102 are allocated to six jobs among the supplied eight jobs and, as a result, four of the jobs are completed. Thus, the value Va of two resource nodes 102 performing the job is increased from Va=20 to Va=40.

In other words, since the rate of the jobs (4 out of 8) whose execution is competed among the supplied jobs has increased, the value Va of the resource node 102 for which execution of the job is not completed is increased.

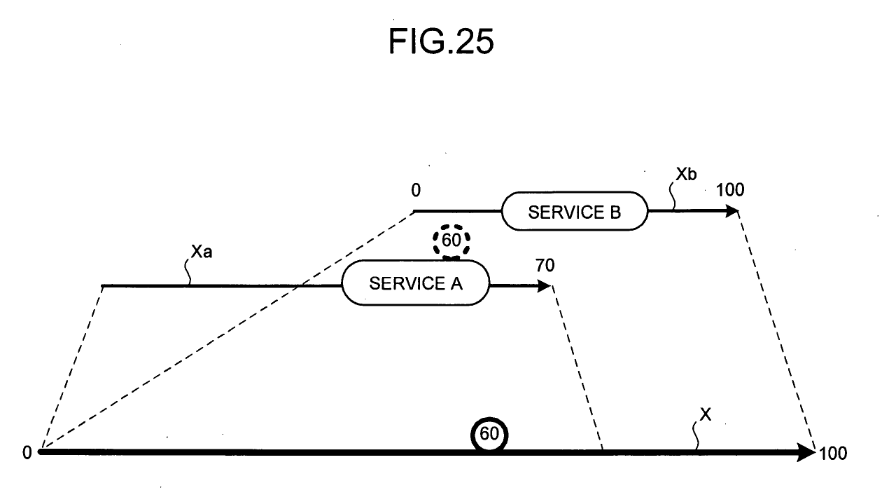

Referring to FIG. 25, after yet further given time has elapsed, the resource nodes 102 are allocated to seven jobs among the supplied eight jobs and, as a result, six of the jobs are completed. Thus, the value Va of two resource nodes 102 performing the job is increased from Va=40 to Va=60.

In other words, since the rate of the jobs (6 out of 8) whose execution is competed among the supplied jobs has increased, the value Va of the resource node 102 whose execution of the job is not completed is increased.

According to the brokering processing shown in FIGS. 22 through 25, the priority of the resource node 102 performing the job can be set higher in accordance with the rate of the jobs whose execution is completed among the supplied jobs. Thus, the execution of the job can be completed stably for the currently executed job, so that the execution of the whole jobs can be completed early.

Next, a case where the priority of the resource node 102 is set in accordance with the number of times assigned to the jobs for other services while executing the job for a certain service will be described. When the resource node 102 executing the job for a certain service is switched to other jobs, the job which has been executed until then may be wasted. For this reason, by setting up the higher priority for the job which is switched to other jobs many times, it can prevent the resource node to be switched to other jobs before completing the job execution.

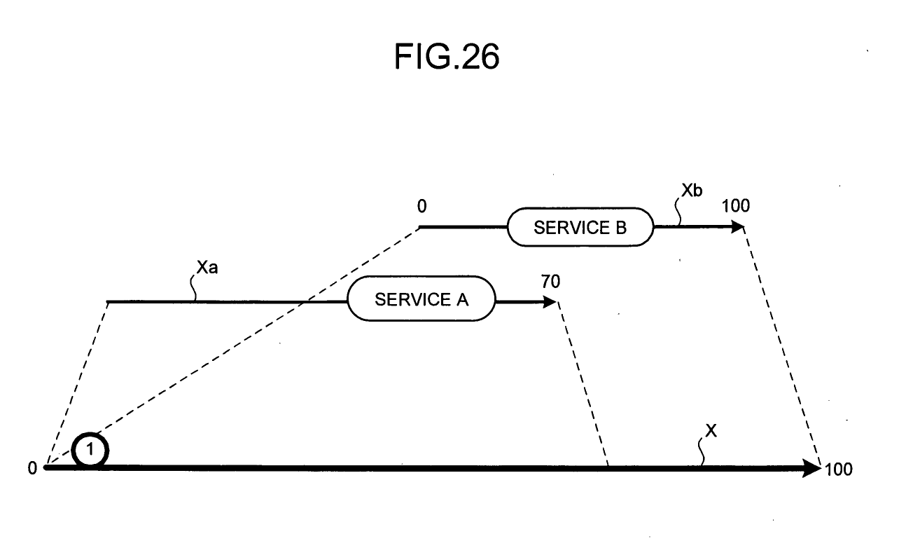

The specific examples of the resource brokering processing will be described where the priority of the resource node 102 is set in accordance with the number of times assigned to the job for other services by reference to FIGS. 26 through 29. FIGS. 26 through 29 illustrate yet other specific examples of the resource brokering processing in the second example.

Referring to FIG. 26, there is the resource node 102 executing the job for the service A, and the value Va thereof is Va=1. This resource node 102 currently executing the job for the service A is allocated to the job for other services.

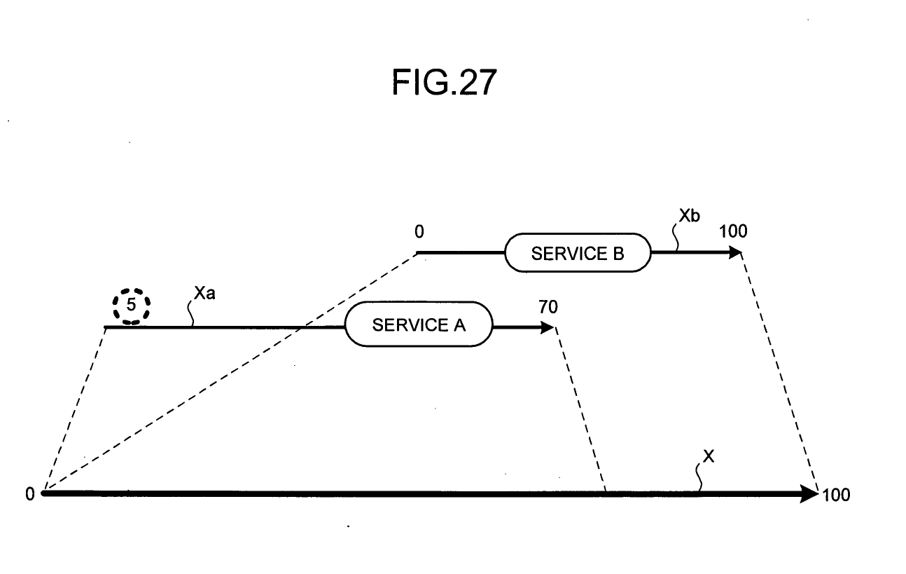

Referring to FIG. 27, since the resource node 102 executing the job for the service A is allocated to the job for other services, the value Va of the resource node 102 is increased from Va=1 to Va=5. At this time, since the job execution for the service A is not completed, the resource node 102 is continuously requested (dotted circle figure in FIG. 27).

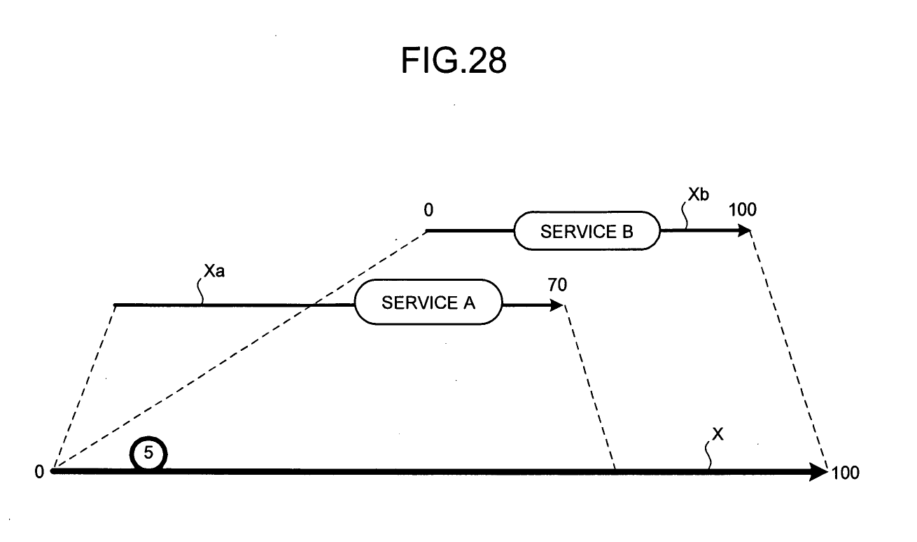

Referring to FIG. 28, the resource node 102 is allocated to the job for the service A to retry the interrupted job execution. At this time, the value Va of the resource node 102 executing the job for the service A is Va=5. This resource node 102 currently executing the job for the service A is allocated to the job for other services.

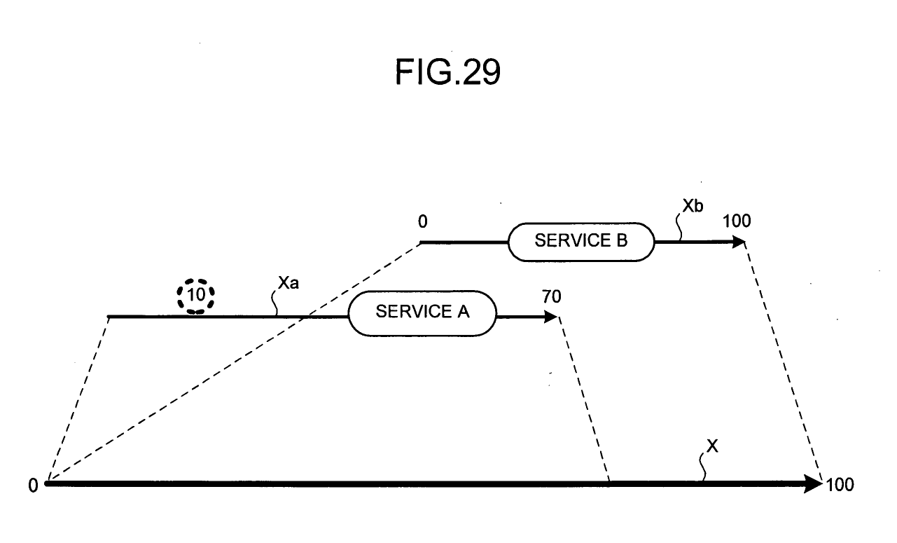

Referring to FIG. 29, since the resource node 102 executing the job for the service A is allocated to the job for other services, the value Va of the resource node 102 is increased from Va=5 to Va=10. At this time, since the job execution for the service A is not completed, the resource node 102 is continuously requested (dotted circle figure in FIG. 29).

According to the brokering processing shown in FIGS. 26 through 29, the priority of the resource node 102 can be set higher every time the job execution is retried. For this reason, the resource node 102 with the large number of times of retry can be excluded from the switching target to other services, so that resource starvation can be avoided as a result.

As described above, according to the resource brokering program product, the recording medium which recorded the program product, the resource brokering apparatus, and the resource brokering method, the respective services can be smoothly provided.

The resource brokering method described in the embodiments can be realized by executing a program that is preliminarily prepared by the computer, such as a personal computer and a workstation. This program is recorded on a computer-readable recording medium, such as the HD, the FD, the CD-ROM, the MO, and the DVD, and is executed by being read from the recording medium by the computer. This program may also be a transmission medium that can be distributed via a network, such as the Internet.

According to embodiments described above, the respective services can be smoothly provided.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a resource brokering program causing a computer to execute:
setting, for each of a plurality of services, a value of resource nodes relatively to a predetermined standard, the resource nodes used for the services;
accepting a request for one service among the services;
detecting whether a resource node to be used for the one service is insufficient;
determining, when it is detected that the resource node is insufficient at the detecting, whether the value of the resource node used for the one service is higher than a value of a resource node used for a service other than the one service; and
switching the resource node to be used for the one service to the resource node that has been used for the other service, based on a result of determination at the determining.

2. The computer-readable recording medium according to claim 1, wherein the setting includes setting the value of the resource node used for the other service so as to vary depending on a condition of the resource node.

3. The computer-readable recording medium according to claim 2, wherein the condition includes an execution time of the resource node.

4. The computer-readable recording medium according to claim 2, wherein the condition includes a processing performance of the resource node.

5. The computer-readable recording medium according to claim 2, wherein the condition includes a use frequency of the resource node.

6. The computer-readable recording medium according to claim 2, wherein the condition includes a location of the resource node.

7. The computer-readable recording medium according to claim 2, wherein the condition includes a specified execution time of the resource node.

8. The computer-readable recording medium according to claim 7, wherein the condition includes whether any one of interruption and termination of the resource node is allowed within the specified execution time.

9. The computer-readable recording medium according to claim 2, wherein
the condition includes a completion rate of a set of jobs related to the other service, the completion rate indicative of a rate of jobs whose execution has been completed among the jobs, and
the setting includes setting the value so that the value of a resource node for which jobs are not yet completed to be high based on the completion rate.

10. The computer-readable recording medium according to claim 2, wherein the condition includes a switching frequency of the resource node.

11. The computer-readable recording medium according to claim 1, wherein the switching includes switching to a resource node having a lowest value among resource nodes used for the other service.

12. A resource brokering apparatus comprising:
a setting unit that sets, for each of a plurality of services, a value of resource nodes relatively to a predetermined standard, the resource nodes used for the services;
an accepting unit that accepts a request for one service among the services;
a detecting unit that detects whether a resource node to be used for the one service is insufficient;
a determining unit that determines, when it is detected that the resource node is insufficient by the detecting unit, whether the value of the resource node used for the one service is higher than a value of a resource node used for a service other than the one service; and
a switching unit that switches the resource node to be used for the one service to the resource node that has been used for the other service, based on a result of determination by the determining unit.

13. The resource brokering apparatus according to claim 12, wherein the setting includes setting the value of the resource node used for the other service so as to vary depending on a condition of the resource node.

14. The resource brokering apparatus according to claim 12, wherein the switching includes switching to a resource node having a lowest value among resource nodes used for the other service.

15. A resource brokering method comprising:
setting, for each of a plurality of services, a value of resource nodes relatively to a predetermined standard, the resource nodes used for the services;
accepting a request for one service among the services;
detecting whether a resource node to be used for the one service is insufficient;
determining, when it is detected that the resource node is insufficient at the detecting, whether the value of the resource node used for the one service is higher than a value of a resource node used for a service other than the one service; and
switching the resource node to be used for the one service to the resource node that has been used for the other service, based on a result of determination at the determining.

16. The resource brokering method according to claim 15, wherein the setting includes setting the value of the resource node used for the other service so as to vary depending on a condition of the resource node.

17. The resource brokering method according to claim 15, wherein the switching includes switching to a resource node having a lowest value among resource nodes used for the other service.
